(19) United States
(12) Patent Application Publication
(10) Pub. No.: US 2009/0302005 A1
(43) Pub. Date: Dec. 10, 2009

(54) PROCESSES FOR TEXTURING A SURFACE PRIOR TO ELECTROLESS PLATING

(75) Inventors: Lawrence Bernard Kool, Clifton Park, NY (US); Michael David Feldstein, Princeton, NJ (US); Eugenio Giorni, Firenze (IT); Dennis Michael Gray, Delanson, NY (US); Thomas Stephen Lancsek, Trenton, NJ (US); Francesco Sorbo, Firenze (IT); Steven Alfred Tysoe, Ballston Spa, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 12/132,805

(22) Filed: Jun. 4, 2008

(51) Int. Cl. C23F 1/00; B05D 3/10; B05D 1/18

(52) U.S. Cl. 216/108; 427/309; 427/437

(57) ABSTRACT

Process for roughening a surface of a base metal substrate includes contacting the surface with an aqueous solution comprising oxalic acid, sulfuric acid, and hydrogen peroxide at a temperature and for a period of time effective to roughen the surface to an average roughness greater than 60 Ra, removing a modest amount of base material, and generating no narrow and deep crevices at all. The surface is roughened prior to application of an electroless coating onto the substrate.

### BACKGROUND

The present disclosure generally relates to processes for texturing a surface prior to electroless nickel plating.

Steel components of industrial and marine gas turbine engines are subjected in normal use to a variety of operating conditions, particularly in terms of the ambient atmosphere. Because of this, steel substrates are often coated with an erosion and corrosion resistance coating.

In order to improve adhesion of the erosion and corrosion resistant coating, it is generally known that the roughness of a surface may be an important constituent in a bonding or coating operation. The surface texture or roughness provides a “mechanical key” for the coating material or adhesive used in the bonding operation, to facilitate the attachment of the coating material or bonding material layer to the parent material and to insure the structural integrity of the finished component.

Conventional methods of surface preparation, used in heavy industry, such as gas turbine engine manufacturing, basically include mechanical processes, such as grit blasting, honing, grinding and the like. Each of these methods involves contacting a surface with an abrasive medium; these methods typically are not easily controlled for very precise surface preparation, and would not generally be employed where a particular pattern is desired for forming a mechanical key. Conventional surface preparation methods can also introduce undesirable deformation or other damage into the surface or substrate; the abrasive material may become embedded in some parent materials or otherwise leave behind particulate contaminants or residue which will require an additional process step to clean the surface and remove any contaminants or residue. In addition, some surfaces, such as those found on gas compressor rotors, are coated with nickel so as to provide the corrosion and erosion resistance. Adhesion of the coating can be difficult to achieve particularly in hard-to-reach internal cavities that cannot be accessed via line-of-sight methods such as grit blasting.

Accordingly, there remains a need for improved methods for texturing a surface, especially for those non-line of sight surfaces often found on parts with complex geometries.

### BRIEF SUMMARY

Disclosed herein are processes that generally include roughening a surface of a base metal substrate. In one embodiment, a process for roughening a surface of a base metal substrate comprises contacting the surface with an aqueous solution comprising oxalic acid, sulfuric acid and hydrogen peroxide at a temperature and for a period of time effective to roughen the surface to an average roughness greater than 60 Ra.

In another embodiment, a process of making a turbine component comprises providing an unfinished turbine component; immersing the component with an aqueous solution consisting essentially of oxalic acid, sulfuric acid, and hydrogen peroxide to roughen a surface of the component to an average roughness greater than 60 Ra; and depositing at least one layer of erosion corrosion resistant material on the surface.

In still another embodiment, a process for plating a substrate having at least one non-line of sight surface comprises etching the substrate having at least one non-line of sight surface with an aqueous solution comprising oxalic acid, sulfuric acid and hydrogen peroxide for a period of time effective to provide a surface roughness greater than 60 Ra; and electroless plating a metal onto the substrate having at least one non-line of sight surface.

The disclosure may be understood more readily by reference to the following detailed description of the various features of the disclosure and the examples included therein.

### BRIEF DESCRIPTION OF THE DRAWINGS

Referring now to the figures wherein the like elements are numbered alike:

FIG. 1 illustrates scanning electron micrographs of a base metal substrate surface after contact with an oxalic acid-sulfuric acid solution for a period of 5 minutes at different temperatures; and

FIG. 2 illustrates scanning electron micrographs of a base metal substrate surface after contact with an oxalic acid-sulfuric acid solution for a period of 10 minutes at different temperatures.

### DETAILED DESCRIPTION

The present disclosure is generally directed to a process for texturing a surface of a base metal substrate prior to electroless plating. By way of example, the process can be practiced on base metal substrates formed of carbon steel and low alloy steel. Advantageously, the process is effective for texturing substrates formed of the above materials and having non-line of sight surfaces, thus increasing surface area and improving adhesion of an electroless plated erosion and corrosion resistant coatings. Notable examples of suitable substrates having non-line of sight surfaces include, without limitation, include the compressor rotors, impellers, and the like, of turbine engines.

The process generally includes contacting the base metal substrate with a chemical texturing solution. Contact is not intended to be limited to any particular method and may include immersion, spraying, and the like. In one embodiment, the chemical texturing solution generally includes an acid with optional additions of non-foaming agents, thickeners, and wetting agents. A wetting agent is defined as a substance, usually a surfactant, which reduces surface tension.

In one embodiment, the chemical texturing solution contains oxalic acid, sulfuric acid, hydrogen peroxide and water, with optional additions of non-foaming agents, thickeners, and wetting agents. A wetting agent is defined as a substance, usually a surfactant, which reduces surface tension. In one embodiment, the chemical texturing solution includes, by weight percent, about 0.5 to about 5% oxalic acid, about 0.01% to about 0.5% sulfuric acid (98% w/w), 0.1 to about 5% hydrogen peroxide (35% w/w), with the balance water and any optional additives. In another embodiment, the texturing solution includes, by weight percent, about 1 to about 4% oxalic acid, about 0.05% to about 0.3% sulfuric acid (98% w/w), and 0.5 to 3% hydrogen peroxide (35% w/w), with the balance water and any optional additives. In still another embodiment, the texturing solution includes, by weight percent, about 2.5 to about 3.5% oxalic acid, about 0.5% to about 0.15% sulfuric acid (98%), 0.8 to 2% hydrogen peroxide (35% w/w), with the balance water and any optional additives. A preferred solution contains about 3% oxalic acid, about 0.15% sulfuric acid by weight (98% w/w), 1.5% hydrogen peroxide (35% w/w) with the balance being water. While oxalic acid and sulfuric acid have been used alone and separately in combination with other acids and solvents for similar purposes, the proposed combination provides maximum surface texturing, i.e., roughens, in a uniform manner across the surface without damaging the substrate. In addition, minimal numbers of blind holes or deep crevices narrower than 10 microns are formed. Crevices narrower than 10 microns are prone to formation of hydrogen bubbles during exposure of the substrate to a subsequent electroless plating process. The process itself is environmentally friendly robust and effective to roughen the surface greater than 60 Ra. An additional advantage is that it only removes a modest amount of base metal.

In some embodiments, the process of this disclosure is carried out at temperatures of about room temperature to about 50° C.; with about 20° C. to about 40° C. in other embodiments, and about 20° C. to 30° C. in still other embodiments. The base metal substrate is contacted with the oxalic acid-sulfuric acid-hydrogen peroxide solution at the above described temperature and for a period of time effective to roughen the surface. Generally, the period time is less than 60 minutes for most embodiments, less than 30 minutes for other embodiments, and less than 10 minutes for still other embodiments. In one embodiment, the base metal substrate is exposed to the oxalic acid-sulfuric acid solution at a temperature of 30° C. for a period of 10 minutes. In this embodiment, the texturing solution includes, by weight percent, 0.5 to about 5% oxalic acid, about 0.01% to about 0.5% sulfuric acid (98% w/w), 0.1 to about 5% hydrogen peroxide (35% w/w), with the balance water and any optional additives.

Subsequent to texturing, the surface may be coated with a coating. For example, an erosion and corrosion resistant material such as a nickel-based alloy material may be deposited onto the textured surface.

Optionally, the base metal substrate is cleaned with a solvent prior to being treated with the texturing solution. Suitable solvents include, but are not limited to, hydrocarbons (e.g. pentane or hexane); halocarbons; ethers (e.g. ethylether (Et₂O), tetrahydrofuran (“THF”), ethylene glycol monomethyl ether, or 2-methoxyethyl ether (diglyme)); nitriles (e.g. CH₃CN); aromatic compounds (e.g. benzotrifluoride), alcohols, and water. Still further exemplary solvents include lactates, pyruvates, and diols. These solvents include, but are not limited to, acetone, 1,4-dioxane, 1,3-dioxolane, ethyl acetate, cyclohexanone, acetone, 1-methyl-2-pyrodidianone (NMP), and methyl ethyl ketone. Other solvents, include dimethylformamide, dimethylacetamide, N-methyl pyrrolidone, ethylene carbonate, propylene carbonate, glycerol and derivatives, naphthalene and substituted versions, acetic acid anyhydride, propionic acid and propionic acid anhydride, dimethyl sulfone, benzophenone, diphenyl sulfone, phenol, m-cresol, dimethyl sulfoxide, diphenyl ether, terphenyl, and the like. Still further solvents include propylene glycol propyl ether (PGPE), methanol, ethanol, 3-heptanol, 2-methyl-1-pentanol, 5-methyl-2-hexanol, 3-hexanol, 2-heptano, 2-hexanol, 2,3-dimethyl-3-pentanol, propylene glycol methyl ether acetate (PGMEA), ethylene glycol, isopropyl alcohol (IPA), n-butyl ether, propylene glycol n-butyl ether (PGBE), 1-butoxy-2-propanol, 2-methyl-3-pentanol, 2-methoxyethyl acetate, 2-butoxyethanol, 2-ethoxyethyl acetoacetate, 1-pentanol, and propylene glycol methyl ether.

Cleaning may further include high-energy agitation of the cleaning agent with the base metal substrate, e.g., sonification.

Once cleaned, the chemically textured substrate is then electrolessly coated with a metal coating, e.g., nickel. The particular electroless coating process is not intended to be limited. Exemplary electroless coating processes are disclosed in U.S. Pat. Nos. Metallographic results have been obtained that show excellent bonding between the coating and the roughened surface.

In all examples the chemical roughening treatment produces a residue or “smut” as a consequence of incomplete dissolution. This smut is conveniently removed by means of ultrasonic cleaning with a suitable detergent.

The following examples are presented for illustrative purposes only, and are not intended to limit the scope of the invention.

### EXAMPLE 1

In this example, alloy A182F22, substrates were treated with an oxalic-sulfuric acid solution and surface roughness was analyzed. The oxalic acid-sulfuric acid-hydrogen peroxide solution was oxalic acid at 31.25 g/L, sulfuric acid (98% w/w) at 1.25 mL/L, and hydrogen peroxide (35% w/w) at 16 mL/L. The temperature and period of time was varied. The results are shown in Table 1 and contrasted with controls where the substrate was not etched and a substrate containing smut. Surface roughness was measured using a Mitutoyo SJ400 surface analyzer.

TABLE 1

| | | | Ra | Ra |
|---|---|---|---|---|
| | Temp. | Time | (microns, | (Standard |
| Etchant | (° C.) | (minutes) | avg.) | Deviation) |
| Oxalic-Sulfuric-Hydrogen | 20 | 5 | 91 | 10 |
| peroxide | | | | |
| Oxalic-Sulfuric-Hydrogen | 20 | 10 | 79 | 24 |
| peroxide | | | | |
| Oxalic-Sulfuric-Hydrogen | 30 | 5 | 114 | 15 |
| peroxide | | | | |
| Oxalic-Sulfuric-Hydrogen | 30 | 10 | 183 | 25 |
| peroxide | | | | |
| Oxalic-Sulfuric-Hydrogen | 40 | 5 | 86 | 13 |
| peroxide | | | | |
| Oxalic-Sulfuric-Hydrogen | 40 | 10 | 105 | 20 |
| peroxide | | | | |
| Control | — | — | 43 | 3 |
| No Etchant | | | | |
| Control-Contains Smut | — | — | 74 | 11 |

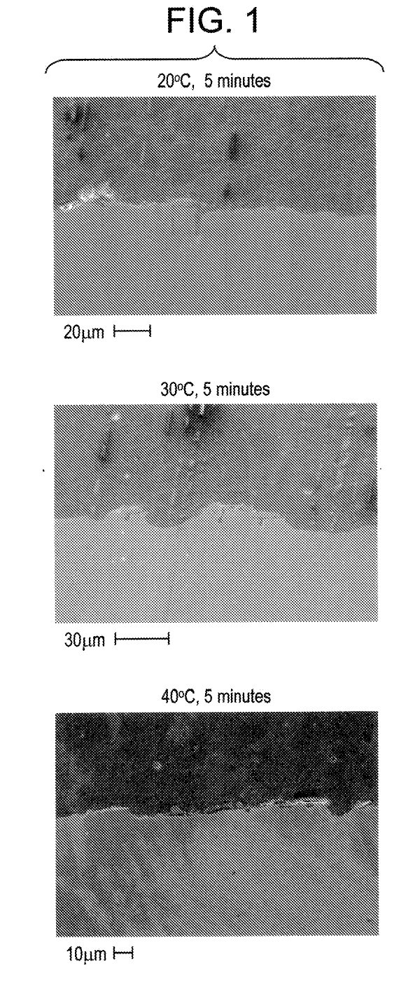

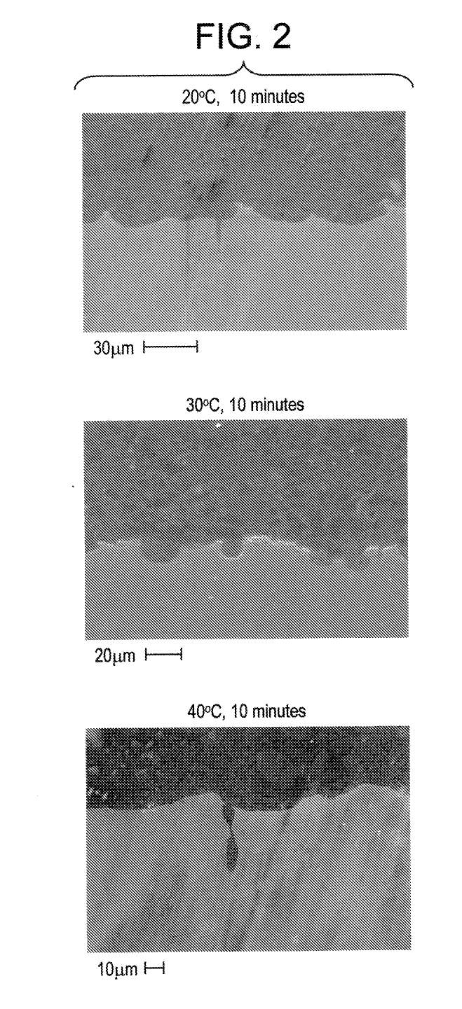

The results show a high surface roughness. In each instance, surface roughness (Ra) was greater than 60. FIGS. 1 and 2 illustrate scanning electron micrographs at the different times and temperatures illustrating the imparted roughness to the surface. The surface roughness is uniform and no blind holes or deep crevices narrower than 10 microns were observed.

It is to be noted that the terms “first,” “second,” and the like as used herein do not denote any order, quantity, or importance, but rather are used to distinguish one element from another. The terms “a” and “an” do not denote a limitation of quantity, but rather denote the presence of at least one of the referenced item. The modifier “about” used in connection with a quantity is inclusive of the stated value and has the meaning dictated by the context (e.g., includes the degree of error associated with measurement of the particular quantity). It is to be noted that all ranges disclosed within this specification are inclusive and are independently combinable. All amounts, parts, ratios and percentages used herein are by weight unless otherwise specified.

While the invention has been described with reference to the embodiments thereof, it will be understood by those skilled in the art that various changes can be made and equivalents can be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the appended claims.

What is claimed is:

1. A process for roughening a surface of a base metal substrate, the process comprising:
contacting the surface with an aqueous solution comprising oxalic acid, sulfuric acid and hydrogen peroxide at a temperature and for a period of time effective to roughen the surface to an average roughness greater than 60 Ra.

2. The process of claim 1, wherein the base metal substrate is a turbine component having at least one non-line of sight surface.

3. The process of claim 1, wherein the aqueous solution comprises, by weight percent, about 0.01 to about 0.5% of the oxalic acid, about 0.1% to about 0.5% of the sulfuric acid (98% w/w) and of the hydrogen peroxide (35% w/w), with the balance being water.

4. The process of claim 1, further comprising a wetting agent, a thickener, or a non-foaming agent.

5. The process of claim 1, wherein contacting the surface with the aqueous solution comprises heating the solution to a temperature within a range from room temperature to 50° C. and for a period of time less than 60 minutes.

6. The process of claim 1, further comprising cleaning the surface prior to contacting the surface with the aqueous solution.

7. The process of claim 1, wherein the surface includes a non-line of sight surface.

8. The process of claim 1, wherein the base metal substrate comprises carbon steel, alloy steel, stainless steel, nickel-based, cobalt-based, or zirconium-based alloys.

9. A process of making a turbine component, comprising:
providing an unfinished turbine component;
immersing the component with an aqueous solution comprising oxalic acid, sulfuric acid, and hydrogen peroxide to roughen a surface of the component to an average roughness greater than 60 Ra; and
depositing at least one layer of erosion corrosion resistant material on the surface.

10. The process of claim 9, wherein the solution is at a temperature within a range of room temperature to 50° C.

11. The process of claim 9, wherein the aqueous solution comprises, by weight percent, about 0.01 to about 0.5% of the oxalic acid, about 0.1% to about 0.5% of the sulfuric acid (98% w/w) and of the hydrogen peroxide (35% w/w), with the balance being water.

12. The process of claim 9, further comprising a wetting agent, a thickener, or a non-foaming agent.

13. The process of claim 9, further comprising cleaning the unfinished turbine component prior to contacting the surface with the aqueous solution.

14. The process of claim 13, wherein cleaning comprises exposing the turbine component to a solvent.

15. The process of claim 9, wherein the component includes non-line of sight surfaces.

16. The process of claim 9, wherein immersing the component with an aqueous solution roughens the surface in an amount greater than 60 Ra.

17. The process of claim 9, wherein the base metal substrate comprises carbon steel, alloy steel, stainless steel, nickel-based, cobalt-based, or zirconium-based alloys.

18. A process for plating a substrate having at least one non-line of sight surface, the process comprising:
etching the substrate having at least one non-line of sight surface with an aqueous solution comprising oxalic acid, sulfuric acid and hydrogen peroxide for a period of time effective to provide a surface roughness greater than 60 Ra; and
electroless plating a metal onto the substrate having at least one non-line of sight surface.

19. The process of claim 18, wherein the metal is nickel, and wherein the base metal substrate comprises carbon steel, alloy steel, stainless steel, nickel-based, cobalt-based, or zirconium-based alloys.

20. The process of claim 18, wherein the aqueous solution comprises, by weight percent, about 0.01 to about 0.5% of the oxalic acid, about 0.1% to about 0.5% of the sulfuric acid (98% w/w) and of the hydrogen peroxide (35% w/w), with the balance being water.
